(19) United States
(12) Patent Application Publication
(10) Pub. No.: US 2022/0053959 A1
(43) Pub. Date: Feb. 24, 2022

(54) ILLUMINATED ROD HOLDER SYSTEM

(71) Applicant: Stalmat Products LLC, Indianapolis, IN (US)

(72) Inventor: Thomas S. Cooler, Carmel, IN (US)

(73) Assignee: Stalmat Products LLC, Indianapolis, IN (US)

(21) Appl. No.: 17/449,481

(22) Filed: Sep. 30, 2021

Related U.S. Application Data
(63) Continuation-in-part of application No. 16/999,760, filed on Aug. 21, 2020.

(51) Int. Cl. A47H 1/102; F21V 33/00; F21V 21/13; A47H 1/022

(52) U.S. Cl. CPC A47H 1/102; F21V 33/0016; F21Y 2115/10; A47H 1/022; F21V 21/13

(57) ABSTRACT

A rod support device including an exterior flange, a female portion configured to receive a telescoping rod, and a male portion configured to extend beyond the surface of a wall. In one aspect, the male portion may include one or more circumferential ribs. In another aspect, the female portion may include a fastener aperture configured to receive a fastener, such as a screw. In yet another aspect, the rod support device may include a cap configured to cover the female portion when not in use. The rod support device may further include an illuminated rod with at least one light transmissive portion and a light source configured to emit light through the light transmissive portion.

### CROSS-REFERENCE TO RELATED APPLICATION

This application is a continuation-in-part of U.S. patent application Ser. No. 16/999,760, filed Aug. 21, 2020, entitled “Rod Holder System”, which is hereby incorporated by reference.

### BACKGROUND

The present disclosure relates to a rod holder system and a method of mounting a rod, for example, a shower curtain rod, a curtain rod, sheers or other material that may hang from or be held up to help shield, divide, cover, display, etc. and/or a clothing rod. Typically, rods are mounted in one of three methods. The most common method involves directly mounting the rod to a wall or surface, this method requires drilling holes and mounting fasteners in the wall. The mount is on the outside of the wall and is subject to damage and abuse. This rod is also serving as a light source, sound and/or communication vehicle. Optionally in some cases, the size of the rod may be 2 to 3 or so inches in diameter in some portions to hold the communication equipment but could still be smaller in diameter at the ends to be held by standard closet rod holders or smaller.

Another common method is utilizing a tension spring rod, which uses outward spring or thread bias to secure the rod in place. However, this method does not result in a securely fastened connection and often results in the rod becoming loose and falling. As should be appreciated, a falling rod is a danger and potential cause of injury for a user.

A third method involves inserting the rod into a separate holding device, the holding device is typically held onto the wall by suction pressure. Similar to the tension spring rod, this method does not result in secure and reliable retention of the rod.

As can be seen above, there is not currently a method of securing a rod that results in a sturdy connection, where the rod is able to be easily removed without unsightly wall or surface damage.

Thus, there is a need for improvement in this field.

### SUMMARY

Disclosed is a rod holder system for use with shower rods, curtain rods, clothing rods, sheers used for purposes like to cover, divide, display, support, hold clothing, products, items and provide a source for sensing motion, producing and hearing sound through the speaker(s) and/or one or more microphone (mic(s)) and the like. Generally, the rod holder system includes an exterior flange, a female portion, which receives a rod, and a male portion that is generally inserted into or formed within a pair of opposed walls or surfaces. In one embodiment, the rod holder system may include an illuminated rod with at least one light transmissive portion and a light source configured to emit light through the light transmissive portion and hold sheers used for purposes like to cover, divide, display, support, hold clothing, products, items and provide a source for sensing motion, producing and hearing sound through the speaker(s) and/or mic(s). In another embodiment, the rod holder system may include a height adjustment mechanism. The rod holder system can also be beneficially used in moving vehicles and SUVs, campers, trucks, military vehicles and water crafts such as boats and cruising crafts as well as on porches between columns or wall surfaces and for trade show displays and tents.

Further forms, objects, features, aspects, benefits, advantages, and embodiments of the present inventions will become apparent from a detailed description and drawings provided herewith

### BRIEF DESCRIPTION OF THE DRAWINGS

FIG. 1 is a perspective view of a rod support device.

FIG. 2 is a front view of the rod support device of FIG. 1 including a fastener aperture.

FIG. 3. is a front view of the rod support device of FIG. 1.

FIG. 4a. is a side view of the rod support device of FIG. 1 including one or more circumferential ribs.

FIG. 4b. is a side view of the rod support device of FIG. 1 including one or more circumferential ribs with one or more hooks.

FIG. 4c. is a side view of the rod support device of FIG. 1 including one or more circumferential ribs with one or more wedges.

FIG. 5 is a side view of the rod support device of FIG. 1 without one or more circumferential ribs.

FIG. 6 is a rear view of the rod support device of FIG. 1 including the fastener aperture.

FIG. 7 is a perspective view of the rod support device of FIG. 1 including a cap.

FIG. 8 is a perspective view of the rod support device of FIG. 1 with the cap inserted.

FIG. 9. is a perspective view of a rod support device with a rectangular external flange.

FIG. 10 is a perspective view of a rod support device with a triangular external flange.

FIG. 11 is a side view of the rod support device of FIG. 2 mounted in a wall or trim surface that may utilize the rod holder such as in a watercraft such a boat and a stationary or moving vehicle such as an SUV, motor home/camper or other such vehicles that are desiring a similar need that can benefit from the rod support device.

FIG. 12 is a front view of the rod support device of FIG. 2 mounted in the wall.

FIG. 13 is a front view of a shower stall including the rod support device of FIG. 1.

FIG. 14 is a perspective view of the rod support device of FIG. 1 mounted in the shower stall.

FIG. 15 is a perspective view of the shower stall of FIG. 14 showing the insertion of a rod into the rod support device of FIG. 1.

FIG. 16 is a perspective view of the shower stall of FIG. 14 with the rod secured in the rod support device.

FIG. 17 is a perspective view of a window opening including the rod support device of FIG. 1.

FIG. 18 is a perspective view of a shower stall including an integral rod support device.

FIG. 19 is a perspective view of a tile including an integral rod support device.

FIG. 20 is a side view of the tile of FIG. 19.

FIG. 21 is a side view of a biased rod holder system.

FIG. 22 is a partial cross-sectional view of the biased rod holder system of FIG. 21

FIG. 23 is a perspective view of an illuminated rod holder system.

FIG. 24 is a perspective view of another embodiment of an illuminated rod holder system.

FIG. 25 is a front view of an illuminated rod support device.

FIG. 26 is a perspective view of an illuminated rod with a pivotable door battery compartment.

FIG. 27 is a perspective view of an illuminated rod with a screw cap battery compartment.

FIG. 28 is a front view of a window opening including an illuminated blind system.

FIG. 29 is a side cross-sectional view of the window opening of FIG. 28.

FIG. 30 is a diagrammatic view of a mobile device including a lighting control application.

FIG. 31 is a side view of a rod holder system with one or more speakers and/or one or more mics.

FIG. 32 is a front view of one embodiment of a rod support device with an integral height adjustment mechanism.

FIG. 33 is a perspective view of the rod support device of FIG. 32.

FIG. 34 is a front view of another embodiment of a rod support device with an integral height adjustment mechanism.

FIG. 35 is a front view of another embodiment of a rod support device with an integral height adjustment mechanism.

FIG. 36 is a front view of another embodiment of a rod support device with an integral height adjustment mechanism.

### DETAILED DESCRIPTION

For the purpose of promoting an understanding of the principles of the inventions, reference will now be made to the embodiments illustrated in the drawings and specific language will be used to describe the same. It will nevertheless be understood that no limitation of the scope of the inventions is thereby intended. Any alterations and further modifications in the described embodiments, and any further applications of the principles of the inventions as described herein are contemplated as would normally occur to one skilled in the art to which the inventions relate. While some embodiments of the invention are shown in great detail, although it will be apparent to those skilled in the relevant art that some features that are not relevant to the present inventions may not be shown for the sake of clarity.

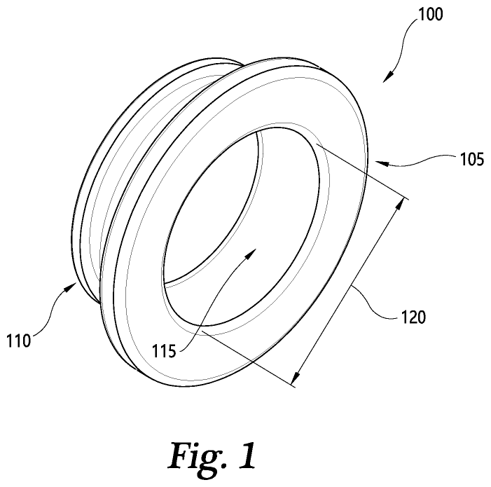

FIG. 1 shows an example of a rod support device 100. The rod support device 100 is configured to securely support a rod, for example a telescoping rod, in a variety of applications. Different applications may result in different material choices for the rod support device 100. For example, the rod support device may be made of metal, ceramic tile, stone, glass, plastic, rubber, wood, stainless steel, and/or any combination thereof. To better-fit individual applications, the rod support device may be paintable, stainable, remain its natural color, and/or any combination thereof.

The rod support device 100 may be used to support shower rods, curtain rods, clothing rods, and/or any similar type rod device. Generally, the rod support device 100 includes an external flange 105, a male portion 110, and a female portion 115. In one example, the external flange 105 is circular. However, in other examples, the external flange 105 may be rectangular, triangular, and/or a custom shape decided by a consumer in order to better suit the décor of a room. The male portion 110 is generally mounted to the external flange 105 and retains a cylindrical shape. The male portion 110 is designed to be mounted inside of a wall in order to provide a secure base for the rod support device 100. The female portion 115 is generally cylindrical in order to secure a rod, however, in the event that the rod has ends that are not circular in shape, the female portion 115 may be altered accordingly. For example, if the rod has square ends, the female portion may be rectangular so as to better secure the rod. Similarly, a diameter 120 of the female portion 115 is adjustable based on the intended usage and rod size. For example, if the rod has a diameter of 2 inches, then the diameter 120 of the female portion 115 will be approximately 2.05 inches to create a tight fit with the rod. In other examples, the diameter 120 of the female portion 115 may range from 0.1-12 inches in diameter.

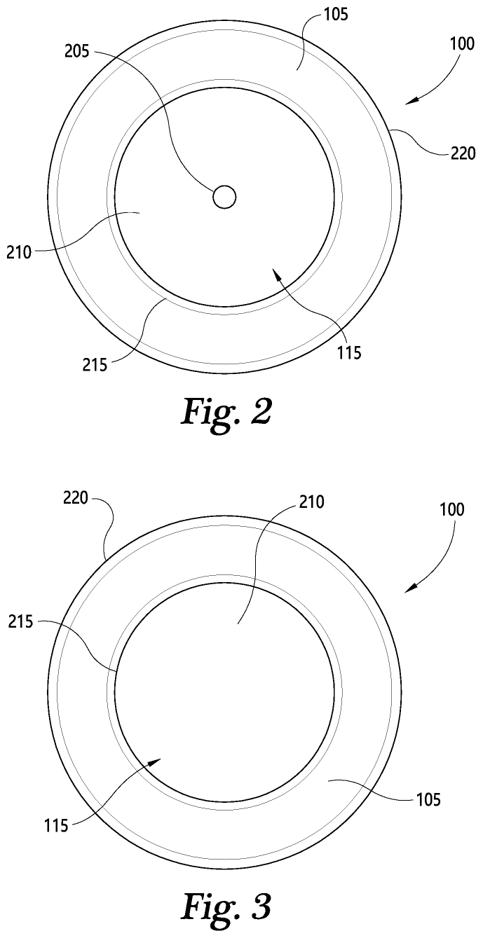

As can be seen in FIGS. 2 and 3, the rod support device 100 may include variations based on the intended usage. For example, FIG. 2 shows the rod support device 100 including one or more fastener apertures 205. In one embodiment, the fastener aperture 205 is located in and defined by a base 210 of the female portion 115 and is configured to provide additional security when mounting the rod support device 100 in the wall. The fastener aperture 205 is configured to receive a fastener such as a screw, molly bolt, toggle bolt, bolt, rivet, anchor, nail, and/or any combination thereof. In an example embodiment, a molly bolt (or similar device) is integrated with the rod support device 100. The molly bolt allows the rod support device to be inserted into a wall with a smaller opening. Once the rod support device is inserted into the wall, the fastener (typically a machine screw) in the molly bolt may be turned clockwise to expand the sleeve and grip into the interior surface of the wall. Thus, a secure connection is established without the need for an oversized opening in the wall surface. Additionally, as shown in both FIG. 2 and FIG. 3, the exterior flange 105 may include both an interior beveled edge 215 and an exterior beveled edge 220.

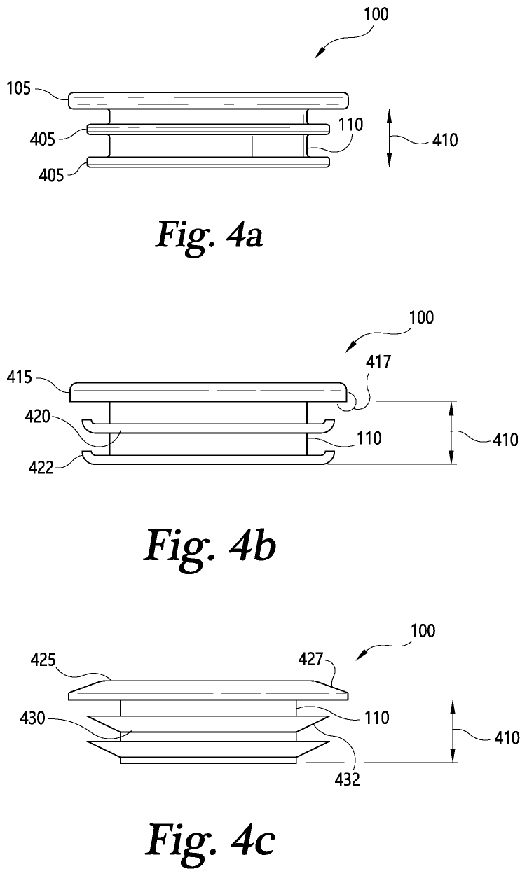

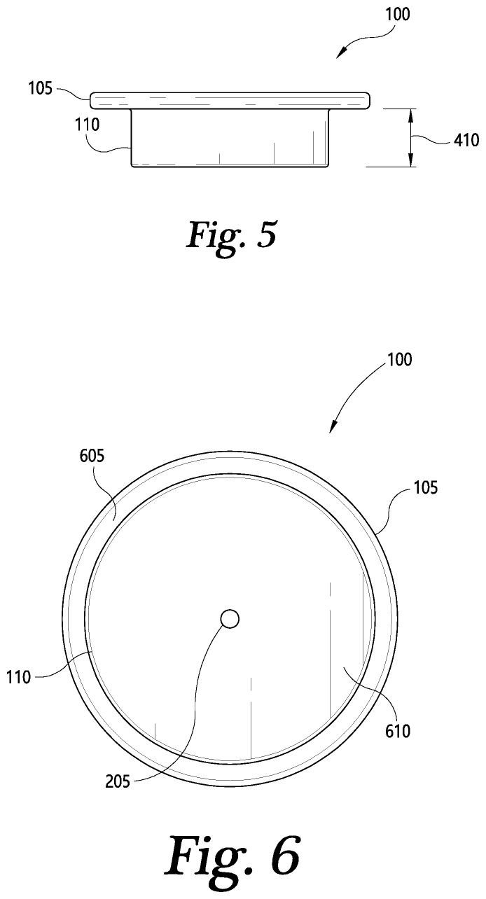

Turning to FIGS. 4a, 4b, 4c, and 5, the rod support device 100 is shown with multiple variants based on the intended usage. Looking to FIG. 4a, the rod support device 100 is shown with one or more circumferential ribs 405. The circumferential ribs 405 create a ridged surface on the male portion 110, which in turn work to further secure the rod support device 100 in the wall, preferably in a stud, and prevent failure. Turning next to FIG. 4b, the rod support device 100 is shown with a modified exterior flange 415. The modified exterior flange 415 is configured to create a water-tight fit with the wall based on a 90° angle 417 formed by the flange. The rod support device 100 in FIG. 4b further includes one or more modified circumferential ribs 420. The modified circumferential ribs 420 include at least one hook 422. The hook 422 is configured to prevent removal of the rod support device 100 by “hooking” or engaging the wall once installed. Furthermore, the bend described by the hook 420 facilitates an easy installation of the rod support device 100, but difficult removal. Similar to FIG. 4b, FIG. 4c shows an example of the rod support device 100 with a wedge shaped external flange 425. The wedge shaped external flange 425 includes a wedge 427. The wedge 427 is configured to provide less of a “lip” or protrusion from the wall. The less protrusion, the less potential that the flange will be exposed to strong forces that could lead to failure. Also shown in FIG. 4c, the rod support device 100 includes one or more wedge shaped circumferential ribs 430. The wedge shaped circumferential ribs 430 include a wedge 432. The wedge 432 is configured to flex or bend when the rod support device is mounted or pushed into the wall. This flex allows for easy installation in the wall and a reduction in the amount of force needed to “push” the device into the wall opening. However, the shape of the wedge 432 prevents removal of the rod support device 100 by catching on the wall or stud as an outward pulling force is applied. In an alternate embodiment, shown in FIG. 5, the male portion 110 is free of any circumferential ribs resulting in a smooth surface area. This embodiment allows for a less drilling required to mount the rod support device 100 in the wall.

FIGS. 4a, 4b, 4c, and 5 each show an example of a depth 410. The depth 410 describes the total distance from the inside of the exterior flange to the exterior of the base of the female portion. Described another way, the depth 410 describes the thickness of the male portion 110. Generally, the depth 410 is embedded in and hidden within the wall where the rod support device 100 is mounted and provides structure to the system. The external flange 105, (typically about ¼ inch, ⅛ inch thick, or thinner), when installed is proud, and is proud (extending from) the installed wall surface. Note, throughout “wall” may include drywall, masonry, trim wood, and/or other surfaces. Conversely, optionally the depth 410 (as well as with other embodiments in this document) is preferably greater than ⅜^{th} inch so as to extend beyond drywall and into a stud.

FIG. 6 shows a rear view of the rod support device 100. From this view, we are able to see an inside surface 605 of the exterior flange 105 as well as an exterior surface 610 of the base 210. The inside surface 605 is generally configured to abut a wall surface and prevent rod support device 100 from receding or falling into the wall. The exterior surface 610 is configured to abut a stud or framing in the wall and create a solid backstop for the rod support device 100.

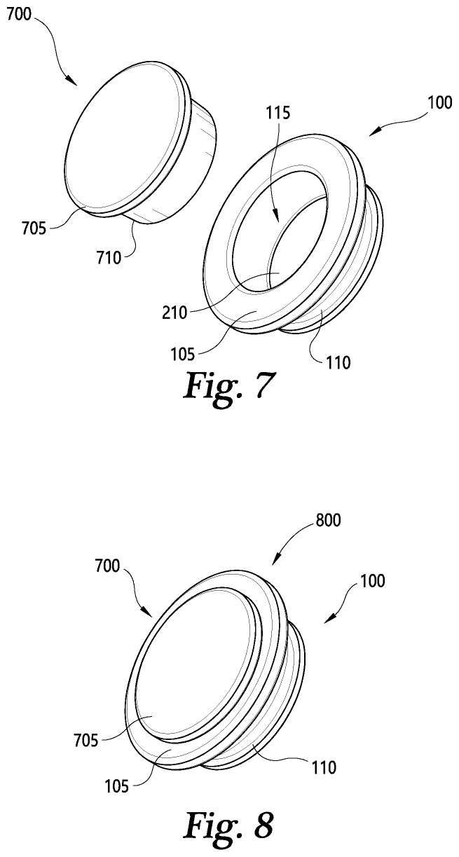

FIGS. 7 and 8 show an optional cap 700 interacting with the rod support device 100. The cap 700 may include a head 705 connected to a plug 710. The cap 700 is generally configured for use when a rod is not inserted into the rod support device 100. The plug 710 of the cap 700 is inserted into the female portion 115 of the rod support device 100 and is secured via a friction fit. The friction fit mechanism allows for the cap 700 to be easily removed and added as needed. Generally, the function of the cap 700 is to provide a watertight seal for the rod support device 100, thus preventing wear and tear on the system. Optionally, the cap 700 may be decorated to serve as an artistic piece to the room when the rod is not in use. In one example, the cap 700 is made of a polymeric plastic material. However, in other examples, the cap may be made of metal, plastic, rubber, wood, stainless steel, and/or any combination thereof.

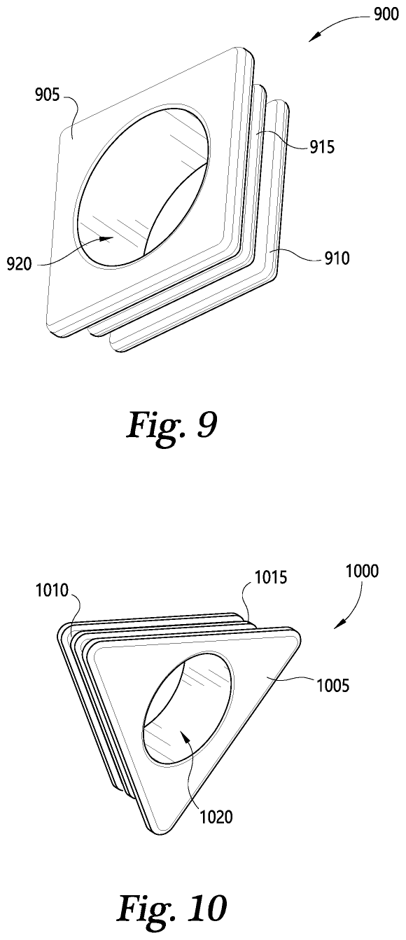

Shown in FIGS. 9 and 10 are two possible variations for the rod support device. FIG. 9 shows a variation of the rod support device 900 where an exterior flange 905 is generally rectangular in shape. Similarly, one or more circumferential ribs 910 are rectangular in shape to correspond with the shape of the exterior flange 905. However, the male portion 915 and the female portion 920 remain cylindrical in shape so as to best secure a rod. FIG. 10 shows a variation of the rod support device 1000 where an exterior flange 1005 is generally triangular in shape. Similarly, one or more circumferential ribs 1010 are triangular in shape to correspond with the shape of the exterior flange 1005. However, the male portion 1015 and the female portion 1020 remain cylindrical in shape so as to best secure a rod. It should be appreciated that the previous are just two examples and other shapes and designs are envisioned as well. For example, a U shape, W shape, Hexagonal shape, and/or any other polygonal shape. Additionally, each component can be shaped differently, for example, the exterior flange may be rectangular while the female portion is triangular and the one or more circumferential ribs are circular.

In contrast, with the circular shaped support devices (see e.g. FIGS. 1-8) the outer diameter of the male portion 110 (FIG. 5) or the optional ribs 405 of the male portion (FIG. 4) is optionally either at or near one and one half inch or two inch in diameter. This facilitates installation using standard hole saws of those dimensions with the rod support snugly fitted therein.

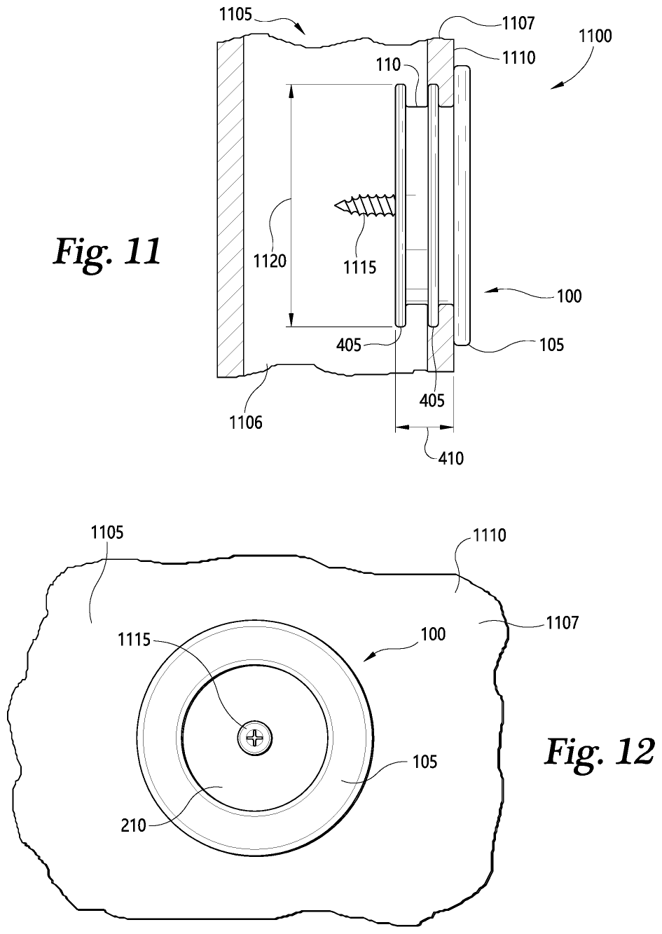

Turning to FIGS. 11 and 12 the rod support device 100 is shown mounted in a wall 1105. The wall 1105 may be comprised of a variety of building materials. For example, the wall may be made of wood, tile, concrete, drywall, fiberboard, plywood, plastic, fiberglass, metal, rubber, and/or any combination thereof. In the example embodiment, the wall 1105 is made of wood framing 1106 with drywall 1107 mounted to the framing 1106. The drywall 1107 generally includes an exterior surface referred to here as a first surface 1110. The first surface 1110 is typically the surface through which the rod support device 100 is mounted.

Multiple variations in the method of mounting the rod support device are envisioned, however, in the interest of space an example embodiment and method of mounting will be explained here. To begin a user selects an installation location for the rod support device and marks the intended location on the first surface 1110. Next, the user uses a tool, such as a hole saw or a core drill, to create an opening in the wall 1105 sized according to a diameter 1120 and depth 410 of the male portion 110. The diameter 1120 is variable based on whether the rod support device includes the one or more circumferential ribs 405. In an example where the rod support device includes the one or more circumferential ribs 405, the diameter 1120 is sized according to the diameter of the circumferential ribs 405. In an example where the rod support device does not include any circumferential ribs 405, the diameter 1120 is sized according to the diameter of the male portion 110. The opening may change location based on the intended usage of the rod holder system 100. For example, the opening may be drilled through the drywall and into the framing of the wall for higher strength applications. In another example, the opening may be drilled into the drywall for lower stress applications and more flexibility in placement. In yet another example, the opening may be drilled through tile, fiberboard, and into framing for extreme stress applications.

Once the opening has been properly sized, the user selects the rod support device variant that best fits the intended use. For example, the user may select a rod support device without circumferential ribs for usage applications where the rod holder system is placed in the framing of the wall. In another example, the user may select a rod support device with circumferential ribs in an application where the rod support device is placed in drywall. In yet another example, the user may select a rod support device with circumferential ribs in an application where the rod support device is placed through tile, fiberboard, and into the framing of the wall.

After the user selects the proper rod support device, the method of mounting is determined. Some examples of common mounting methods include using a fastener, adhesive, and/or using a combination of fasteners and adhesive. To list some non-limiting examples, the user may elect to mount a rod support device without circumferential ribs by using adhesive. In this case, the user will apply adhesive to the inside surface 605 of the exterior flange 105, around the circumference of the male portion 110, and to the exterior surface 610 of the base 210. The adhesive may be a resin, a hot melt adhesive, contact spray adhesive, acrylic adhesive. anaerobic adhesive, epoxy adhesive, conductive adhesive, pressure adhesive, and/or any combination thereof. In the case where the user elects to use the rod support device with the fastener aperture, the rod support device is mounted by securing a fastener 1115 through the fastener aperture 205 and into the framing 1106 of the wall 1105. The fastener 1115 may be a screw, rivet, bolt, nail, and/or any combination thereof. In another example, the user may elect to secure the rod support device using a combination of adhesive and fasteners. In this case, the adhesive is applied to the inside surface 605 of the exterior flange 105 and the fastener 1115 is secured into the framing 1106 of the wall 1105 through the fastener aperture 205.

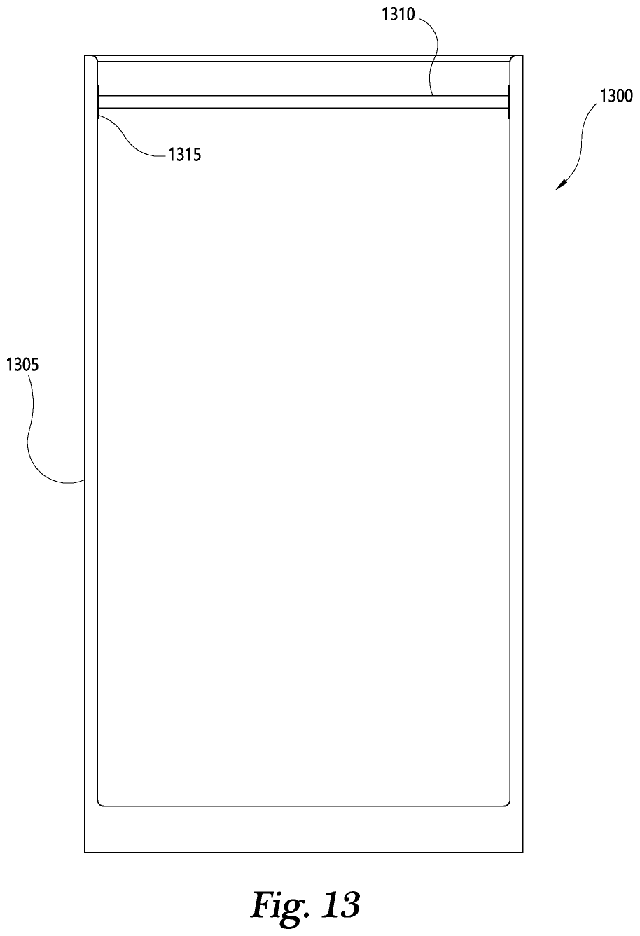

FIG. 13 shows an example of the completed system in a shower stall environment 1300. The system includes a shower stall 1305, a telescoping rod 1310, and one or more rod support devices 1315. As can be seen in the figure, the rod support devices 1315 are generally mounted equidistant from each other and are in direct longitudinal, vertical and lateral alignment. The telescoping rod 1310 is easily removable from the rod support device 1315 in the event the shower stall 1305 needs cleaned or maintained. Furthermore, the rod support device 1315 are securely fastened into the shower stall 1305 and surrounding wall. As a result, someone grabbing the telescoping rod 1310 and applying a downward force will not be able to tear the rod support device 1315 out of the wall and create unsightly damage. Preferably, the rod may be sold in a kit with two supports.

Preferably, the rod, with its material characteristics and cross-sectional moment(s) of inertia, at 4 feet in length will have a center downward buckling failure force that is less than one-half of the downward shear failure force of each support device (installed). The support devices are used in pairs, mounted in opposing walls.

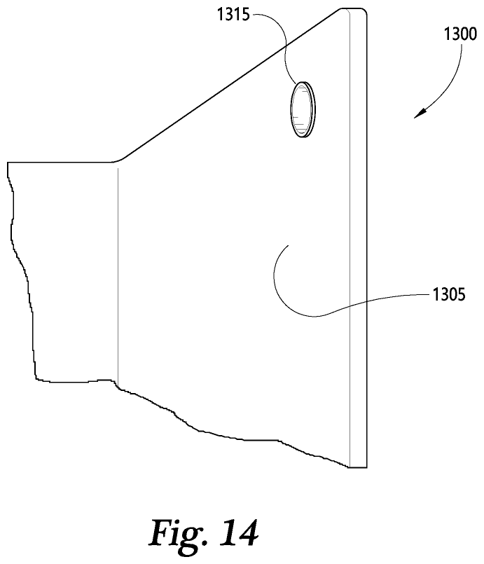

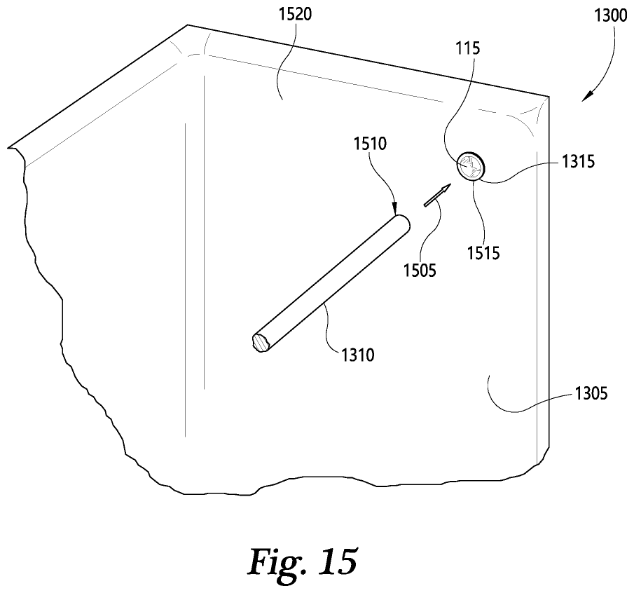

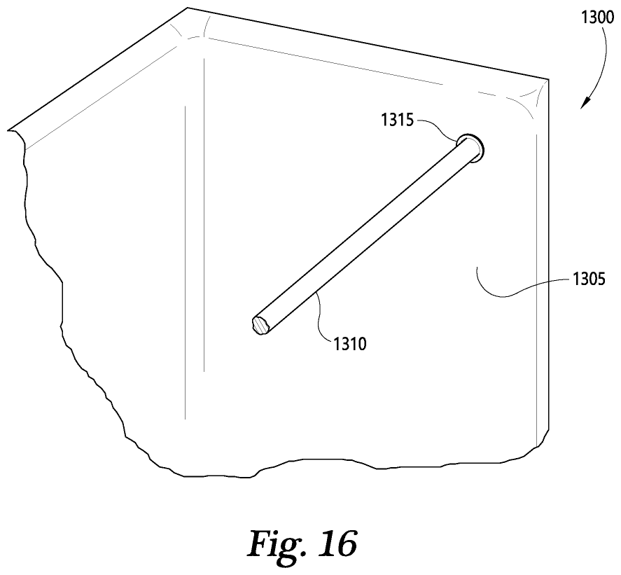

FIGS. 14, 15, and 16 show a magnified version of the optional shower stall environment 1300. FIG. 14 simply shows the rod support device 1315 securely mounted in the shower stall 1305. In FIG. 15, the telescoping rod 1310 is being inserted into the rod support device 1315. Generally, the telescoping rod 1310 is inserted in the manner indicated by arrow 1505. For example, the arrow 1505 indicates that a first end 1510 of the telescoping rod 1310 is inserted into a first rod holder system 1515, located in the first wall 1520 of the shower stall 1305, by pushing the first end 1510 into the female portion 115 of the first rod support device 1515. Following this, the same process is completed with a second end of the telescoping rod. After both the first end 1510 and the second end of the telescoping rod 1310 are secured in the respective female portions 115 of the rod support device 1315, the installation is complete as shown in FIG. 16.

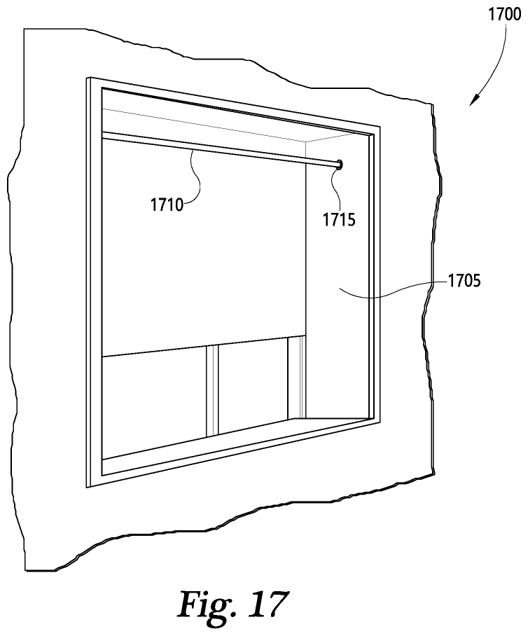

FIG. 17 shows an example of a rod support device mounted in a window opening 1700. This example includes a window opening 1705, a telescoping rod 1710, and one or more rod support devices 1715. The method of installation and usage is similar to that of the shower stall version 1300, however the rod support device 1715 may be used to hang curtains or similar items in front of the window opening 1705 in order to block out sunlight at will.

Optionally, the rod holder is not limited to be not just in a window (or shower), but instead or in addition may have other uses like on a porch, and/or between columns that hold a screen or curtain, etc.

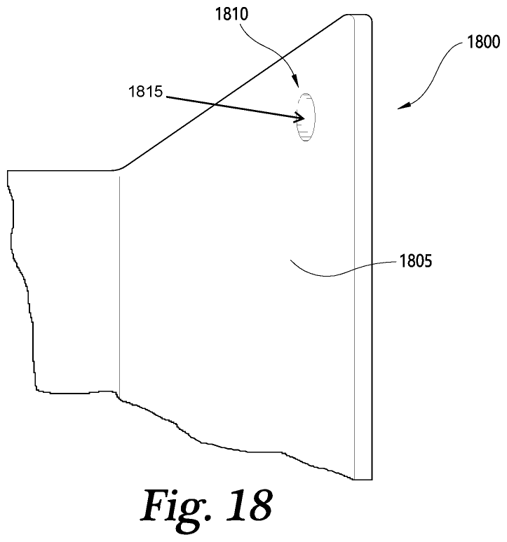

FIG. 18 shows an example of a shower stall with an integrated rod support device 1800. Generally, the shower stall with an integrated rod support device 1800 includes a shower stall 1805 and one or more integrated rod support devices 1810. The integrated rod support devices 1810 work similarly to the separate rod support devices described above in FIGS. 13-16, however, the integrated rod support devices 1810 are molded and manufactured with the shower stall 1805 by the manufacturer. Similar to the separate rod support devices, the integrated rod support device is generally positioned more than 55 inches above the level of the finished floor. In another example, the integrated rod support device is positioned between 65 and 75 inches above the level of the finished floor. In yet another example, the integrated rod support device is positioned 70 inches from the finished floor. The integrated rod support device 1800 also includes a depth 1815; the depth is generally dependent on the application. For example, a depth of more than 3/64^{th} of an inch is generally desired for securing a rod. However, in another example, a depth of less than 3/64^{th} of an inch may be desired for securing rod that is in a lower traffic area.

The manufacturers may mold the shower stall 1805 with various shapes and designs of the integrated rod support device 1800. For example, the manufacturer may mold the shower stall 1805 with a circular integral rod support device, similar to that in FIG. 18. In another embodiment, the manufacturer may mold a support device in the shape of a “U”. In yet another embodiment, the manufacturer may mold a support device in a rectangular shape. As should be appreciated, including the rod support device 1810 at the time of manufacture is advantageous, as it does not result in cost related to construction or retrofitting of an old shower stall.

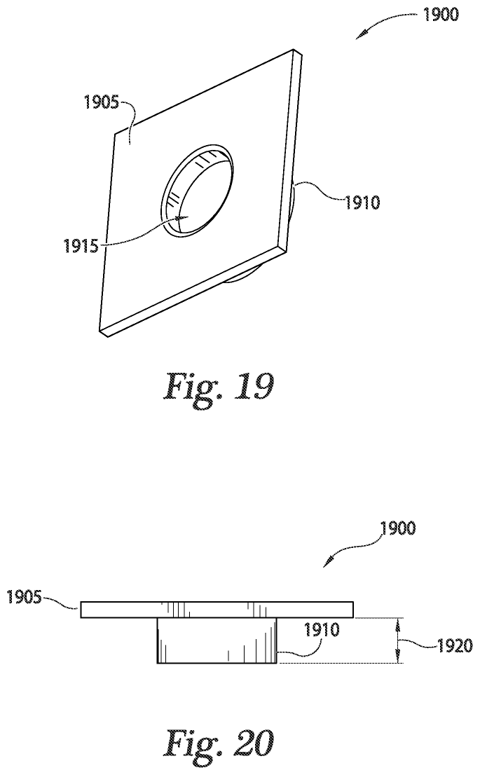

Turning now to FIGS. 19 and 20, a tile, in one embodiment a shower tile, is shown with an integrated rod support device 1900. Similar to what has been described previously, the integrated rod support device 1900 includes an exterior flange 1905, a male portion 1910, and a female portion 1915. The components of the integrated rod support device 1900 are generally made from ceramic, carbon fiber, porcelain, glass, marble, stone, plastic, and/or any combination thereof. The tile used may come in a variety of shapes and sizes depending on the application, for example, the tile may be a square, rectangular, triangular, subway tile, mosaic tile, hexagonal tile, plank tile, and/or any combination thereof. In an example embodiment, the tile is the 4×4 ceramic type tile with a depth 1920 of no more than 1″. In another example, the tile is a hexagonal glass tile with the depth 1920 being no more than 0.5″. In yet another example, the tile is a rectangular subway type tile with the depth 1920 being no more than ⅜″. As should be appreciated, integrating the rod support device 1900 into a tile allows a user to quickly and easily mount the rod support device wherever is convenient. In addition, the integrated rod support device provides a clean and uniform appearance without the need to retrofit existing tile and risk damage to surrounding structures.

In alternative embodiments rather than a flush outer wall and the recess within the wall or tile, the support device, (for example 1900 in FIGS. 19 and 20 and/or 1800 in FIG. 18), may instead extend proud of the tile or other wall (shower wall). Such device is integral with the tile or shower walls. In such case, there is less or no part of the support device extending into the wall (away from the outer wall and away from the other, opposing support device); and, this has particular advantage with tile. For example, with a flush or nearly flush inner wall of the tile, it may more readily be adhered to backing (e.g. cement board or otherwise) without drilling a hold in the backing. That helps maintain water tight integrity in a shower.

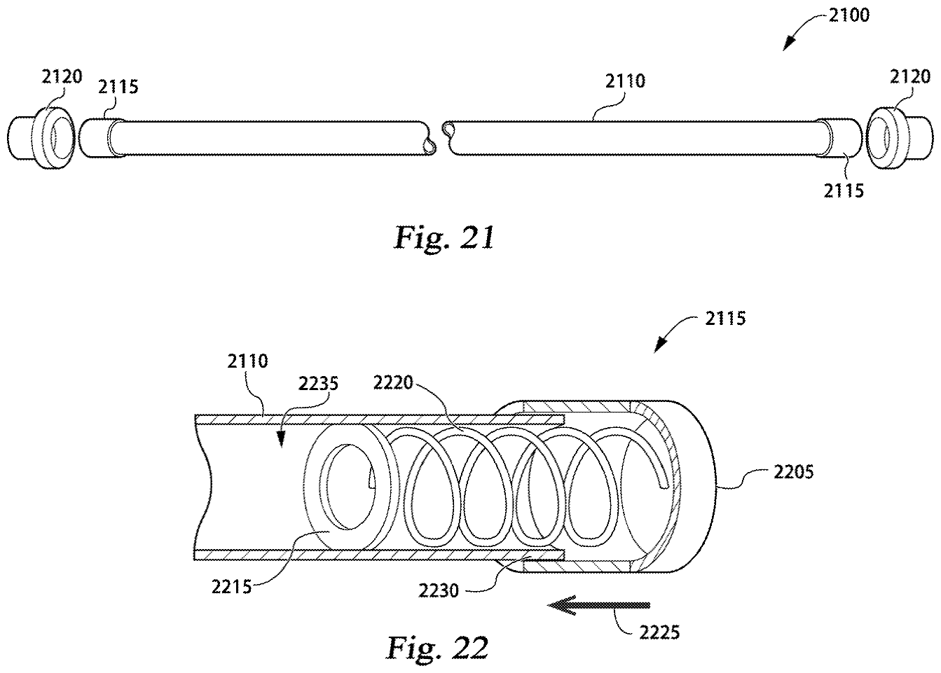

Illustrated in FIGS. 21 and 22 are examples of a biased rod holder system 2100. The biased rod holder system 2100 includes a rod 2110 with an outwardly biased end cap 2115. The end cap 2115 enables a user to mount the rod 2110 within one or more rod support devices 2120. As is best shown in FIG. 22, the biased end cap 2115 includes a cap 2205 surrounding an outer portion 2230 of the rod 2110 and a biasing component 2220 housed within an inner portion 2235 of the rod 2210. The biasing component may be a variety of shapes and materials depending on the application, for example, the biasing component may be a spring, a compressible rubber material, and/or a compressible polymeric material. Similarly, the rod 2110 and the end cap 2115 may be a variety of shapes. For example, the rod 2110 and end cap 2115 substantially cylindrical in shape. In other embodiments, the rod 2110 and end cap 2115 may be rectangular, hexagonal, polygonal, and/or triangular in shape.

The end cap 2205 is configured to move in the direction indicated by arrow 2225 when compression forces are applied to the rod 2110. When compression force is applied, the biasing component 2220 is compressed between the cap 2205 and a plug 2215. As should be appreciated, compression of the cap 2205 reduces the overall length of the rod 2110 enabling the rod to fit within the support devices 2120. Once the rod is within the support devices 2120, the biasing component 2220 expands. Expansion of the biasing component 2220 creates a tension force with respect to the support devices 2120 and secures the rod 2110 in position.

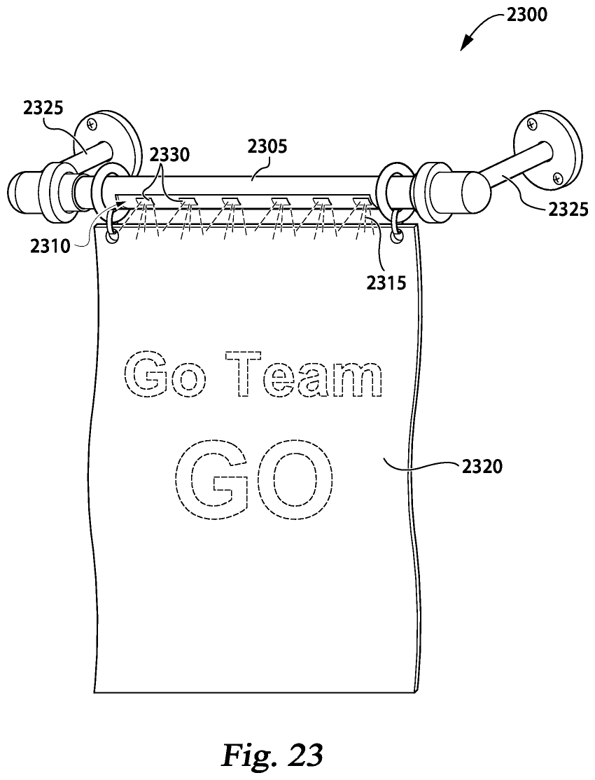

An example of an illuminated rod holder system 2300 is shown in FIG. 23. The rod holder system 2300 includes a rod 2305 and one or more rod support devices 2325. The rod 2305 includes a light transmissive portion 2310. The light transmissive portion 2310 enables one or more light emitting diodes (LEDs) 2330 housed within the rod 2305 to illuminate an area around the rod 2305 via one or more light rays 2315. In one embodiment, the light transmissive portion 2310 is located on an outer portion of the lower half of the rod to direct light rays downward. In another embodiment, the rod 2305 is entirely light transmissive so as to allow illumination around the entire rod. In yet another embodiment, the rod 2305 may include more than one light transmissive portion located on different areas of the rod.

The rod 2305 may be in the form of a shower rod, a curtain rod, a clothing rod, and/or a decorative rod. Typically the rod 2305 has a diameter of about one and one-quarter inch (1¼″) and a length of at least thirty inches (30″). However, in other examples, the rod may have a diameter greater or less than 1¼ “and a length less than 30”. The support devices 2325 may be in the form discussed previously (e.g. in FIGS. 1-3). Optionally, the support devices 2325 may be in the form of shelving brackets, closet brackets, and/or curtain brackets. In one example, the rod supports a decorative tapestry 2320. In other examples, the rod supports a shower curtain, window blinds, clothing, and/or other hanging objects.

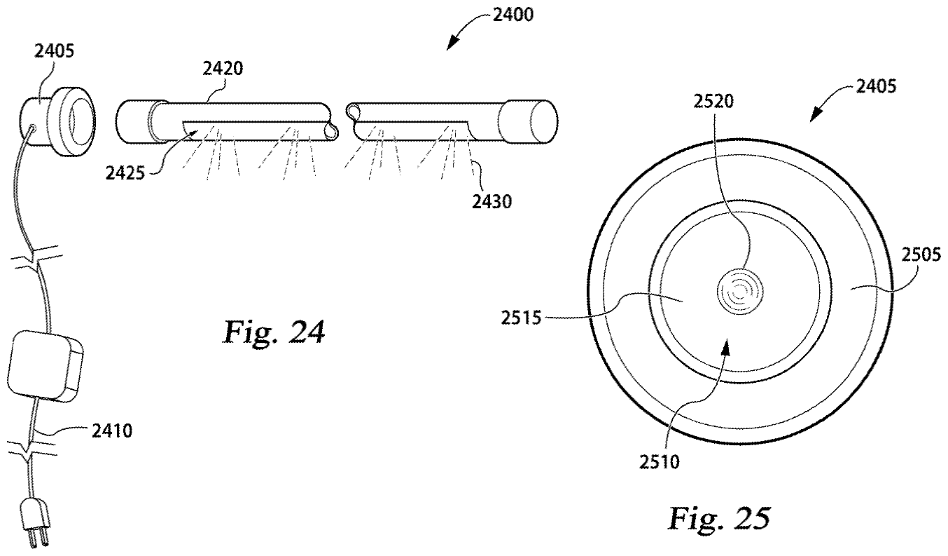

FIGS. 24 and 25 show an example of another example of a rod holder system 2400. The rod holder system 2400 includes at least one illuminated rod support device 2405 and a rod 2420. Similar to what has been described above in FIGS. 1-3, the illuminated rod support device 2405 includes an external flange 2505, a female portion 2510, and a base 2510. Mounted to the support device 2405 is a cord 2410 and a controller 2415. The cord 2410 generally includes a power wire and a ground wire and is configured to supply power to at least one light source 2520. The controller 2415 is configured to allow a user to connect wirelessly to the system 2400 to control the light source 2520. The light source 2520 is housed in the base 2515 of the female portion 2510 and is configured to emit light through a light transmissive portion 2425 of the rod 2420. The light source 2520 may be in the form of one or more LEDs, a halogen bulb, a fluorescent bulb, a solar bulb, and/or a high-intensity discharge (HID) lamp.

In an example embodiment, the rod 2420 is inserted into the support device 2405 and functions as a clothing rod, a shower rod, a decorative rod, and/or a curtain rod. If a user determines that lighting is needed, the user may power on the light source 2520 within the support device 2405. In one example, the light source is powered on via a mobile application on a mobile phone. In other examples, the light source may be powered on by a wall switch and/or a manual switch on the support device. Following this, light is emitted through the light source 2520 and into the rod 2420. The light then transmits through the light transmissive portion 2425 and illuminates an area around the rod via one or more light rays 2430.

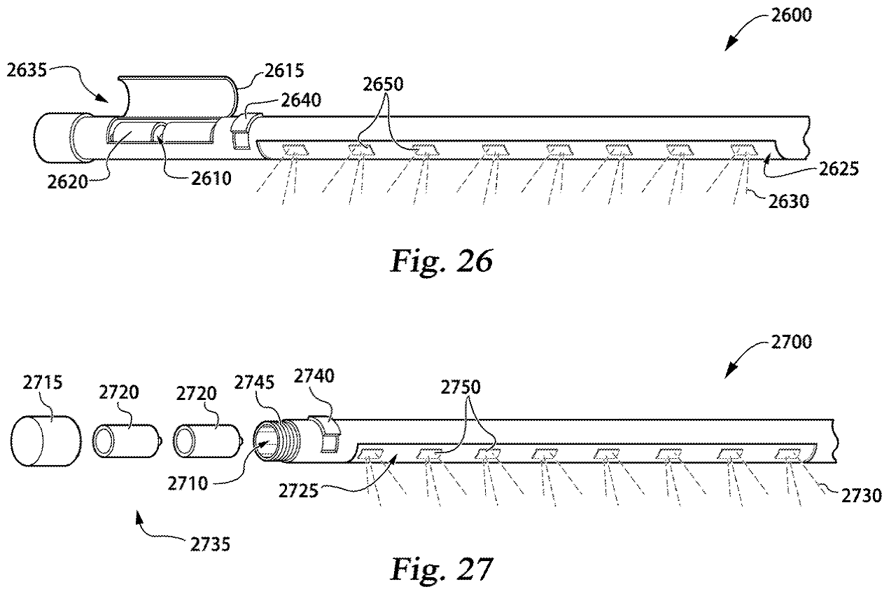

FIGS. 26 and 27 show variations of a rod 2600 with a pivotable door battery compartment 2635 (shown in FIG. 26) and a rod 2700 with a screw cap battery compartment 2735 (shown in FIG. 27). The pivotable door battery compartment 2635 includes a door 2615, a compartment 2610, and one or more batteries 2620. The door 2615 enables a user to cover and secure the batteries 2620. As should be appreciated, the batteries 2620 may be any form of battery shape and/or material. The compartment 2610 enables the batteries 2620 to electrically connect with one or more LEDs 2650 in order to power the LEDs. Power to the one or more LEDs 2650 is controlled by a switch 2640. The switch 2640 is generally an on/off type switch enabling a user to turn the LEDs 2650 on or off to control the emission of light rays 2630 from a light transmissive portion 2625. However, in other embodiments, the switch 2640 may be a digital switch on a mobile application.

The screw cap battery compartment 2735 includes a cap 2715, a compartment 2710, and one or more batteries 2720. The cap 2715 is generally threaded and mates with a threaded end 2745 of the rod 2700. The compartment 2710 receives the one or more batteries 2720, which are then secured within the compartment 2710 by the cap 2715. As discussed above, the batteries 2720 electrically connect with one or more LEDs 2750 in order to provide power to the LEDs. Power to the LEDs 2750 is controlled by a switch 2740. The switch is generally in the form of an on/off type switch enabling a user to turn the LEDs 2750 on or off to control the emission of light rays 2730 from a light transmissive portion 2725. In other embodiments, the switch 2640 may be a digital switch on a mobile application.

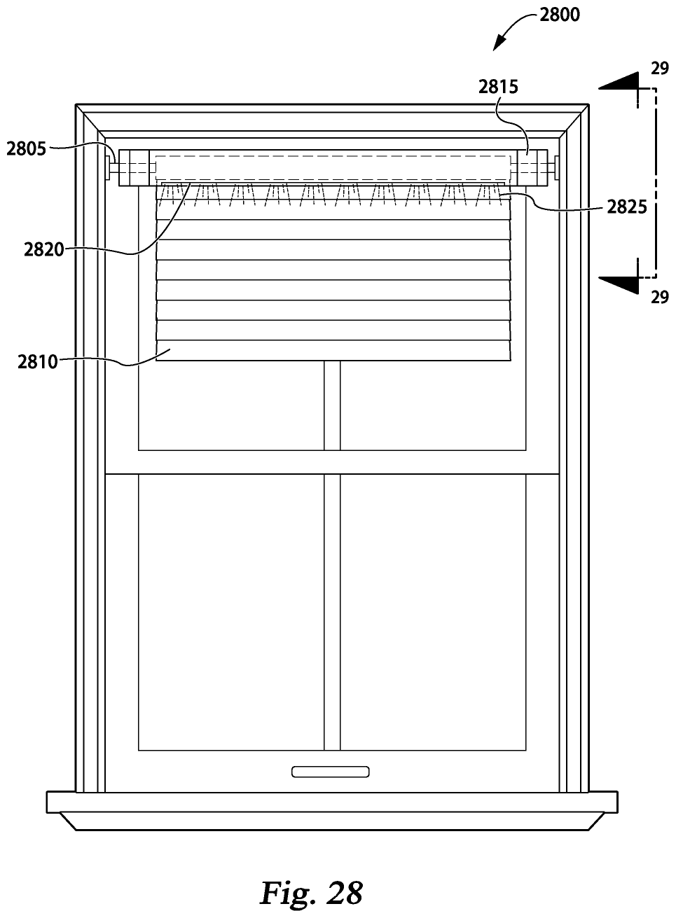

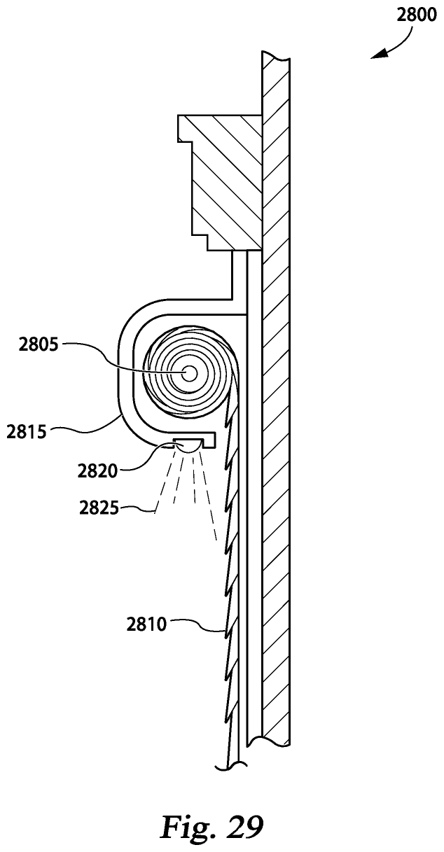

Illustrated in FIGS. 28 and 29 is an example of an illuminated blind system 2800. The blind system 2800 includes a rod 2805, blinds 2810, and a headrail 2815. The blinds 2810 are typically in the form of automatic roll-up blinds. However, the blinds may be in the form of manual roll-up blinds, automatic venetian blinds, manual venetian blinds, automatic vertical blinds, and/or manual vertical blinds. The blinds 2810 are supported by the rod 2805. In some embodiments, the rod 2805 may include a light transmissive portion and one or more LEDs as discussed previously. The headrail 2815 is typically configured to cover the rod 2805 and the rolled up blinds.

The headrail 2815 includes a light source 2820. The light source 2820 may be in the form of one or more LEDs, a halogen bulb, a fluorescent bulb, a solar bulb, and/or a high-intensity discharge (HID) bulb. The light source 2820 is configured to emit one or more light rays 2825 and illuminate the blinds 2810. In another embodiment, the light source 2820 may be used to illuminate an entire room in place of a typical lamp/light fixture. The light source 2820 typically extends along the entire length of the headrail 2815. In other embodiments, the light source 2820 may only extend for a portion of the headrail 2815.

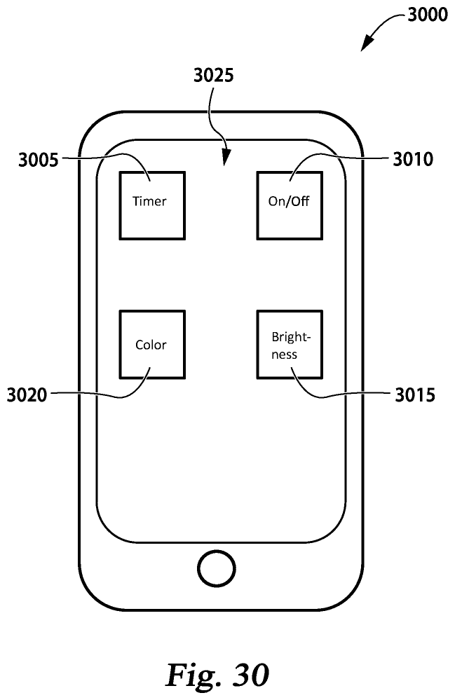

FIG. 30 shows an example of a mobile device 3000. The mobile device 3000 is able to connect to the illuminated rod and/or illuminated rod support device via WiFi and/or Bluetooth to control the rod/support device via an app 3025. The app 3025 typically includes settings for a timer 3005, on/off controls 3010, light color 3020, and/or light brightness 3015. The timer 3005 is used to create custom settings for automatically powering the light source. For example, the timer may be set to turn the lights on at 8:00 PM and turn the lights off at 8:00 AM. The on/off controls 3010 are used to remotely turn the light source on/off without having to physically contact the illuminated rod/support device. The light color setting 3020 enables a user to modify the color of the emitted light based on personal preference. The brightness setting 3020 enables a user to modify the light intensity based on personal preference. For example, a user may decrease the light intensity prior to going to sleep.

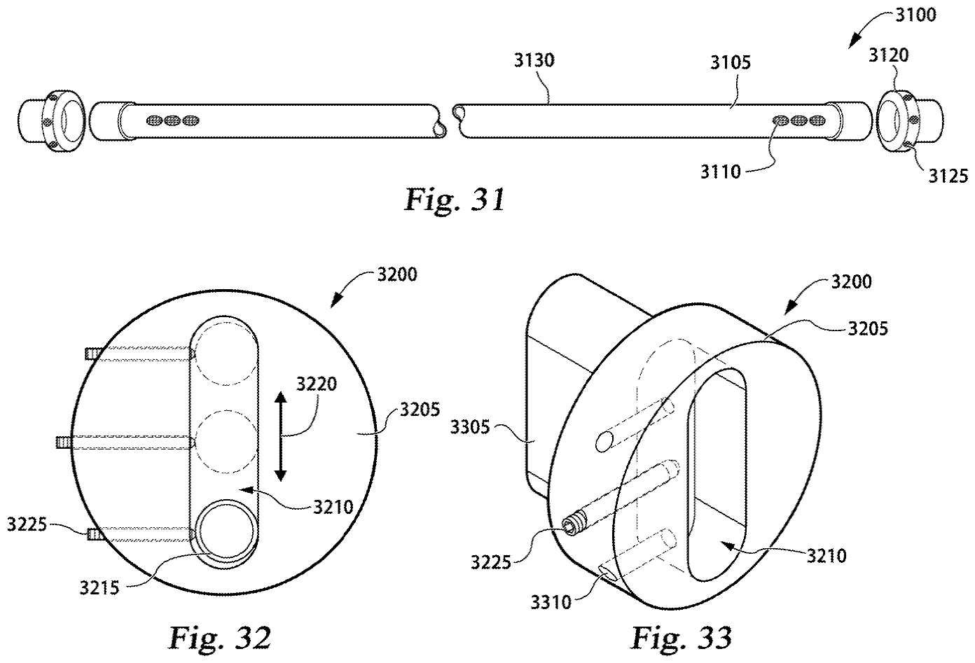

FIG. 31 illustrates an example of an acoustic rod holder system 3100. The rod holder system 3100 includes a rod 3105 with one or more speakers and/or mic(s) 3110. The speakers and/or mic(s) 3105 are generally located on an exterior surface 3130 of the rod 3105. In one embodiment, a rod support device 3115 includes one or more speakers and/or ind(s) 3125 located around an exterior circumference of a flange portion 3120. In some examples, the speakers and/or mic(s) 3110 may be located on only the rod 3105. In other examples, the speakers 3125 may be located only on the rod support device 3115. In yet other examples, the speakers 3110, 3125 are located on both the rod 3105 and the rod support device 3115. Typically, speakers and/or mic(s) 3110, 3125 are controlled via Bluetooth. For example, through the app 3025 of FIG. 30 on a mobile and/or wireless device.

Optionally, for use with the mics the system may include noise filtering or cancelling electronics (software or otherwise) to cancel or reduce ambient shown noise from shower water. This option facilitates a phone call while in the running shower. Tom

FIGS. 32 and 33 show an example of a rod support device with an integral height adjustment system 3200. The rod support device 3200 includes a flange 3205 with a female portion 3210 and a male portion 3305. The male portion 3305 is designed to mount inside of a wall in order to provide a secure base for the rod support device 3200. The female portion 3210 is sized to receive a rod 3215, such as a shower rod, curtain rod, clothing rod, and/or any other form of rod.

The female portion 3210 is generally an oblong oval shape in order to provide multiple height positions for the rod 3215. As indicated by arrow 3220, the rod 3215 can be moved vertically within the female portion 3210 in order to adjust the height of the rod 3215. Once the desired height has been reached, the user may tighten set screw 3225 via clockwise rotation to secure the rod 3215 at the desired height. In one embodiment, the flange 3205 includes a plurality of preset apertures 3310 corresponding to varying height settings for the rod 3215. For example, the apertures 3310 may be preset in 1 inch increments, half inch increments, one and a half inch increments, and/or any other incremental separation as may be requested by a user. In another example, the apertures 3310 and the set screw 3225 utilize a threaded connection mechanism.

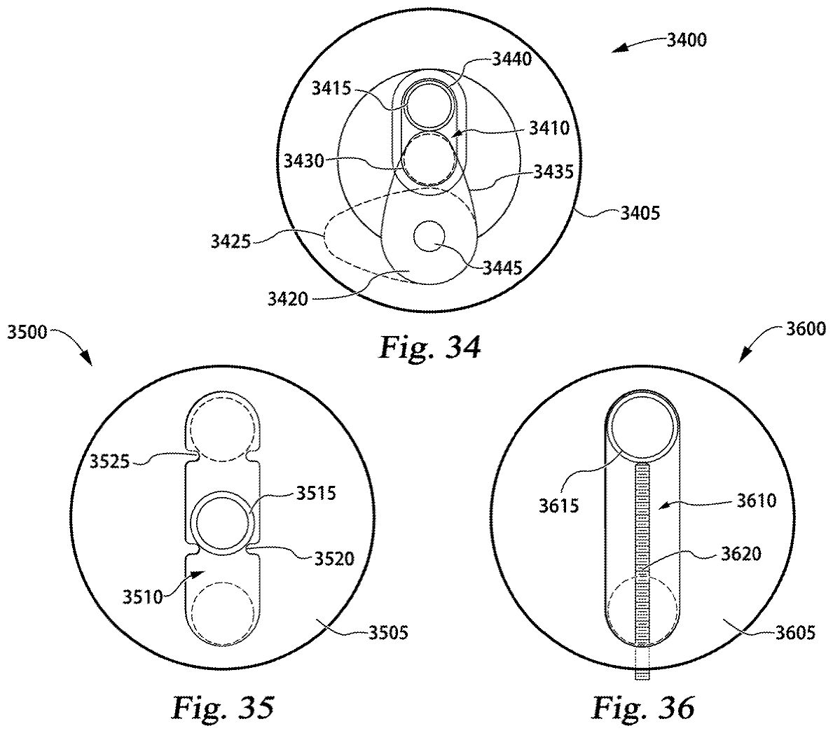

FIG. 34 depicts another example of a rod support device with an integral height adjustment system 3400. The rod support device 3400 includes a flange 3405 defining a female portion 3410. The female portion 3410 is sized to receive a rod 3415, such as a shower rod, curtain rod, clothing rod, and/or any other form of rod. Fixed to the flange 3405 is a cam 3420. The cam 3420 typically rotates about a shaft 3445 from a first position 3425 to a second position 3425. Corresponding to cam 3420 position, the rod 3415 alternates between a first position 3430 and a second position 3440. Generally, the first position 3420 of the rod 3415 is below the second position 3440 of the rod 3415. For example, a user may rotate the cam 3420 from the first position 3425 to the second position 3425 to raise the height of the rod 3415.

FIG. 35 depicts another example of a rod support device with an integral height adjustment system 3500. The rod support device 3500 includes a flange 3505 defining a female portion 3510. The female portion 3510 is sized to receive a rod 3515, such as a shower rod, curtain rod, clothing rod, and/or any other form of rod. Located within the female portion 3510 are one or more standoffs 3520, 3525. The standoffs 3520, 3525 are configured to support the rod 3515 at predetermined height intervals. For example, the standoffs 3520, 3525 may be separated by one (1) inch, two (2) inches, three (3) inches, and/or any other distance. In an example use case, a user may move the rod 3515 from one set of standoffs 3520 to another set of standoffs 3525 to raise the height of the rod 3515. Likewise, the user may move the rod 3515 from one set of standoffs 3525 to another set of standoffs 3520 to lower the height of the rod.

FIG. 36 depicts another example of a rod support device with an integral height adjustment system 3600. The rod support device 3600 includes a flange 3605 defining a female portion 3610. The female portion 3610 is sized to receive a rod 3615, such as a shower rod, curtain rod, clothing rod, and/or any other form of rod. To raise the height of the rod 3610, a set screw 3620 is rotated in a clockwise direction. To lower the height of the rod 3610, the set screw 3620 is rotated in a counterclockwise direction. As should be appreciated, the set screw 3620 enables the rod 3615 to be positioned at any height within the female portion 3610.

### Glossary of Terms and Alternative Wordings

While examples of the inventions are illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the inventions. No limitation of the scope of the inventions is thereby intended. Any alterations and further modifications in the described examples, and any further applications of the principles described herein are contemplated as would normally occur to one skilled in the art to which the inventions relate. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“About” with reference to numerical values generally refers to plus or minus 10% of the stated value. For example, if the stated value is 4.375, then use of the term “about 4.375” generally means a range between 3.9375 and 4.8125.

“Adhesive” generally refers to any non metallic substance applied to one or both surfaces of two separate parts that binds them together and resists their separation. For example, an adhesive can bond both mating surfaces through specific adhesion (e.g., molecular attraction), through mechanical anchoring (e.g., by flowing into holes in porous surfaces), and/or through fusion (e.g., partial solution of both surfaces in the adhesive or its solvent vehicle). Some non-limiting examples of adhesives include liquid adhesives, film adhesives, resin adhesives, rubber adhesives, silicone-based adhesives, mastics, metal-to-metal adhesives, plastic adhesives, rubber adhesives, sprayable adhesives, and hot melt adhesives, to name just a few.

“And/or” is inclusive here, meaning “and” as well as “or”. For example, “P and/or Q” encompasses, P, Q, and P with Q; and, such “P and/or Q” may include other elements as well.

“Circumference” generally refers to the perimeter of a circle or ellipse. That is, the circumference would be the arc length of the circle, as if it were opened up and straightened out to a line segment. Something said to be around the circumference would be located around the outside of the circle or ellipse.

“Controller” generally refers to a mechanical or electronic device configured to control the behavior of another mechanical or electronic device. A controller may include a “control circuit” configured to provide signals or other electrical impulses that may be received and interpreted by the controlled device to indicate how it should behave.

“Fastener” generally refers to a hardware device that mechanically joins or otherwise affixes two or more objects together. By way of nonlimiting examples, the fastener can include bolts, dowels, nails, nuts, pegs, pins, rivets, screws, and snap fasteners, to just name a few.

“Female” means here a description of a structure that connects to another structure that includes hollow portions for receiving portions of a corresponding male connector.

“Flange” generally refers to a projecting flat rim, collar, or rib on an object, serving to strengthen or attach or to maintain position on a rail.

“Friction Fit” or “Interference Fit” generally refers to a form of fastening between two tight fitting mating parts that produces a joint, which is held together by friction after the parts are pushed together.

“Horizontal” generally refers to a plane or direction. An item that moves in the sideways direction is generally said to move horizontally. For example, a lever fixed on one end to a rod that is able to move to the left and right is said to move horizontally.

“Lamp” generally refers to an electrical device configured to produce light using electrical power. The generated light may be in the visible range, ultraviolet, infrared, or other light. Example illumination technologies that may be employed in a lamp include, but are not limited to, incandescent, halogen, LED, fluorescent, carbon arc, xenon arc, metal-hallide, mercury-vapor, sulfer, neon, sodium-vapor, or others.

“Led Lamp” generally refers to an electrical device that uses Light Emitting Diodes (LEDs) to produce light using electrical power. A lamp may include a single LED, or multiple LEDs.

“Light Emitter” means a device or devices which when electrically energized give off light, such as a bulb or an LED, alone, in groups or rays or otherwise.

“Light Transmissive” means permitting light to pass through it, such as being transparent, translucent, with or without tint, lenses, ridges and/or prisms.

“Male” means here a description of a structure that connects to another structure that includes portions that fill or fit inside the hollow portion of a corresponding female connector.

“Metal” generally refers to a material that is both ductile and malleable. Additionally, metal refers to a generally hard and hardy material, often used in construction and fabrication. Some examples of metals are: steel, aluminum, iron, brass, bronze, copper, gold, silver, stainless steel, galvanized steel, and tool steel to name a few.

“Mounted” means physically attached to or held in place by. This may be by fasteners, adhesives, conduits, brackets, over molded plastic, or otherwise.

“Multiple” as used herein is synonymous with the term “plurality” and refers to more than one, or by extension, two or more.

“Optionally” as used herein means discretionary; not required; possible, but not compulsory; left to personal choice.

“Plastic” has the meaning, polymer or monomer material.

“Polymer” means here a material characterized by a molecular structure formed from the repetition of subunits bonded together. Examples include, but are not limited to, plastics or rubber.

“Power Cable” generally refers to a cable configured to transfer electrical power as part of an electrical circuit. A power cable may be used exclusively to transfer power, or it may be used to also transfer signals.

“Predominately” as used herein is synonymous with greater than 50%.

“Reflect” has the meaning, to bounce some or all light rays off a surface or facet.

“Rib” as used herein means a raised ridge above another surface. It may be contiguous or interrupted.

“Telescope” or “Telescoping” generally refers to an object that includes sections that are able to fit or slide into each other, so that the object can be made longer or shorter at will. For example, a telescoping rod may include 2 sections of slightly different diameters enabling the rod halve or double its length by pulling the sections apart or pushing them together.

“Thickness” generally refers to the measure of the distance between opposite sides of an object. As used here, the thickness of an object that is positioned between two surfaces is measured from between the two sides of the object that contact the surfaces.

“Tile” generally refers to a thin slab of clay, concrete, or other material used in construction or decoration. Tile may be rectangular, circular, triangular, and/or hexagonal. Additionally, tile may be used on roofs, in bathrooms, kitchens, and/or a variety of places where a hard and resilient material is needed. Some common tile types are: ceramic tile, glass tile, porcelain tile, cement tile, marble tile, mosaic tile, granite tile, and/or limestone tile to name a few.

“Vertical” generally refers to a plane or direction. An item that moves upward or downward is generally said to move vertically. For example, an item that is able to move up and down is said to move vertically.

“Wall” means here is structure that forms a solid surface. It may be a portion of a house, room, or otherwise. A wall may be planar or multiplanar and may be constructed of any of a variety of materials, including, but not limited to metal, concrete, wood, or plastic.

“Wall Thickness” generally refers to the measured distance between the opposing outside surfaces of an object.

What is claimed is:

1. A rod for mounting to a left side and a right side holder, comprising:
an elongated rod body adapted to be held horizontally between the left side holder and right side holder;
said rod body comprising at least one light transmissive portion on an outside surface of said rod body; and,
at least one electrical light source for providing light out through said light transmissive portion.

2. The rod of claim 1, wherein said rod body is substantially cylindrical in its outer surface shape, and wherein said light transmissive portion is generally flush with said outer surface shape.

3. The rod of claim 2, wherein said rod body is substantially cylindrical in its outer surface shape, has a diameter of about one and one-quarter inch, a length of at least 30 inches, and is sufficiently stiff to hold clothing on hangers across its length.

4. The rod of claim 3, wherein said light source comprises a plurality of Light Emitting Diodes (LEDs) within said rod body.

5. The rod of claim 1, wherein said rod body is combined in a set also including at least two side holders.

6. The rod of claim 5, wherein at least one of said side holders comprises a light source for providing light transmissible through said rod body and out through said light transmissive portion.

7. The rod of claim 1, wherein the rod body includes a battery compartment housed at one end of the rod body, wherein the battery compartment includes a screw cap threadedly mounted to one end of the rod body, wherein the battery compartment is configured to receive one or more batteries, and wherein the one or more batteries are held within the battery compartment by the screw cap.

8. The rod of claim 1, wherein the rod body includes a battery compartment housed within the rod body, wherein the battery compartment includes a pivotable door configured to cover the battery compartment, wherein the battery compartment receives one or more batteries, and wherein the one or more batteries are held within the battery compartment by the pivotable door.

9. The rod of claim 1, wherein the rod body includes an adjustable length, and wherein the length is adjusted by an adjustable end cap at one end of the rod body.

10. The rod of claim 9, wherein the adjustable end cap includes a biasing device housed within the end cap, and wherein the biasing device includes a spring.

11. The rod of claim 1, wherein the light source is turned on and off via a mobile application.

12. The rod of claim 1, wherein the light source has an adjustable brightness, and wherein the brightness is adjusted via a mobile application.

13. The rod of claim 1, wherein said rod body includes an audio speaker.

14. The rod of claim 1, wherein said rod body is water resistant and is at least four feet long, and is sufficiently rigid to support a shower curtain.

15. The rod of claim 1, wherein said rod body is water resistant and includes at least one microphone.

16. A rod for mounting to a left side and a right side holder, comprising:
an elongated rod body adapted to be held horizontally between the left side holder and right side holder;
said rod body comprising at least includes at least one audio speaker; and,
an electrical power source to power said audio speaker.

17. The rod of claim 16, wherein said rod body is water resistant and is at least four feet long, and is sufficiently rigid to support a shower curtain.

18. The rod of claim 16, wherein said rod body is water resistant and includes at least one microphone.

19. The rod of claim 17 wherein said rod body is water resistant and includes at least one microphone.
